(19) United States
(12) Patent Application Publication
(10) Pub. No.: US 2006/0242125 A1
(43) Pub. Date: Oct. 26, 2006

(54) Method, apparatus, and computer program product for assessing a user's current information management system

(75) Inventor: James William Tummins, Lakewood, CO (US)

Correspondence Address: Timothy R. Schulte;Storage Technology Corporation, One StorageTek Drive, Louisville, CO, 80028-4309, US

(73) Assignee: Storage Technology Corporation

(21) Appl. No.: 11/114,067

(22) Filed: Apr. 25, 2005

(51) Int. Cl. G06F 17/30

(52) U.S. Cl. 707/3

(57) ABSTRACT

A method, apparatus, and computer program product are disclosed for assessing a user's current information management system. Multiple contiguous information management system stages are defined. Multiple implementation levels are defined. Particular characteristics for the implementation levels for each one of the stages are specified. Questions are generated regarding the particular characteristics. A value is assigned to potential answers to the questions. Answers are received from a user to the questions. The stage in which the user's current information management system exists is determined utilizing the received answers.

### BACKGROUND OF THE INVENTION

1. Technical Field

The present invention is directed to data processing systems. More specifically, the present invention is directed to a method, apparatus, and computer program product for assessing a user's current information management system.

2. Description of Related Art

Information lifecycle management (ILM) is a sustainable storage strategy that balances the cost of storing and managing information with its changing business value. A well-executed ILM strategy will result in a more agile organization, reduce business risk, and drive down both storage unit and storage management costs. Ultimately, organizations gain solid and immediate business benefit from information lifecycle management by better controlling information assts for competitive advantage.

Currently, there is no method for evaluating a user's particular ILM implementation. Further, there is no method for providing to users recommendations to help a user move from their current ILM implementation to a more well-executed ILM strategy.

Therefore, a need exists for a method, apparatus, and computer program product for assessing a user's particular current ILM implementation and providing recommendations for moving to a more well-executed ILM strategy.

### SUMMARY OF THE INVENTION

A method, apparatus, and computer program product are disclosed for assessing a user's current information management system. Multiple contiguous information management system stages are defined. Multiple implementation levels are defined. Particular characteristics for the implementation levels for each one of the stages are specified. Questions are generated regarding the particular characteristics. A value is assigned to potential answers to the questions. Answers are received from a user to the questions. The stage in which the user's current information management system exists is determined utilizing the received answers.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of computer systems that includes the present invention in accordance with the present invention;

FIG. 2 is a block diagram of a computer system that includes the present invention in accordance with the present invention;

FIG. 3 illustrates a high level flow chart that depicts defining an information maturity model where the model includes a spectrum of levels for each one of a plurality of maturity stages in accordance with the present invention;

FIG. 4 depicts a high level flow chart that illustrates presenting and utilizing an assessment tool to analyze a user's current information management system in accordance with the present invention;

FIG. 5 illustrates a high level flow chart that depicts collecting respondents' answers to an assessment tool to generate average aggregate answers in accordance with the present invention;

FIGS. 6A-6F together depict an example of an assessment tool including a plurality of questions in accordance with the present invention;

FIGS. 7A and 7B together illustrate an example assessment report that was generated utilizing the answers provided as depicted by FIGS. 6A-6F in accordance with the present invention; and

FIGS. 8A and 8B depict characteristics for each one of the implementation levels for each one of the maturity stages in accordance with the present invention.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

The present invention is an assessment tool that determines a user's information management system's current maturity stage. A “system” as used herein includes processes and/or capabilities of a computer system, such as a storage system. A user's system has a particular level of processes and/or capabilities. As the system evolves through the maturity stages defined herein, the user's system will acquire more sophisticated and advanced processes and/or capabilities and may also acquire additional processes and/or capabilities.

The assessment tool includes a series of questions that are presented which ask the user to rank the user's agreement or effectiveness with a statement about a management process. The rankings are scaled from one to five, corresponding roughly with the maturity stages. In some cases the scores are weighted.

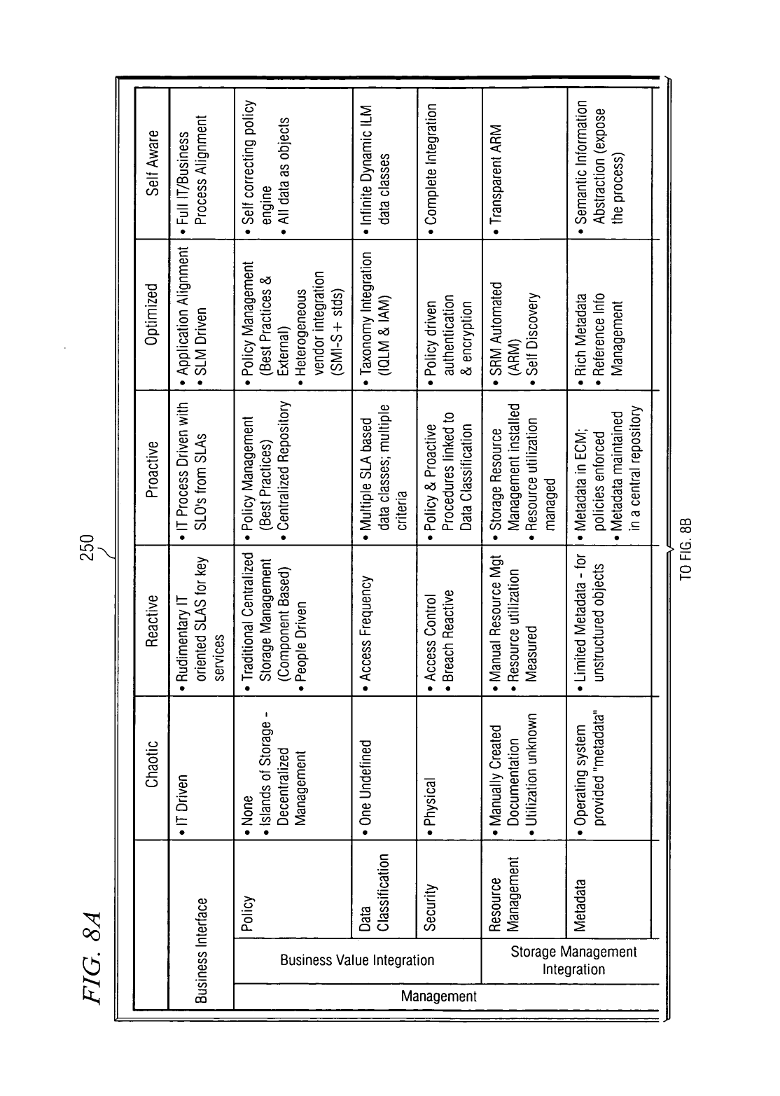

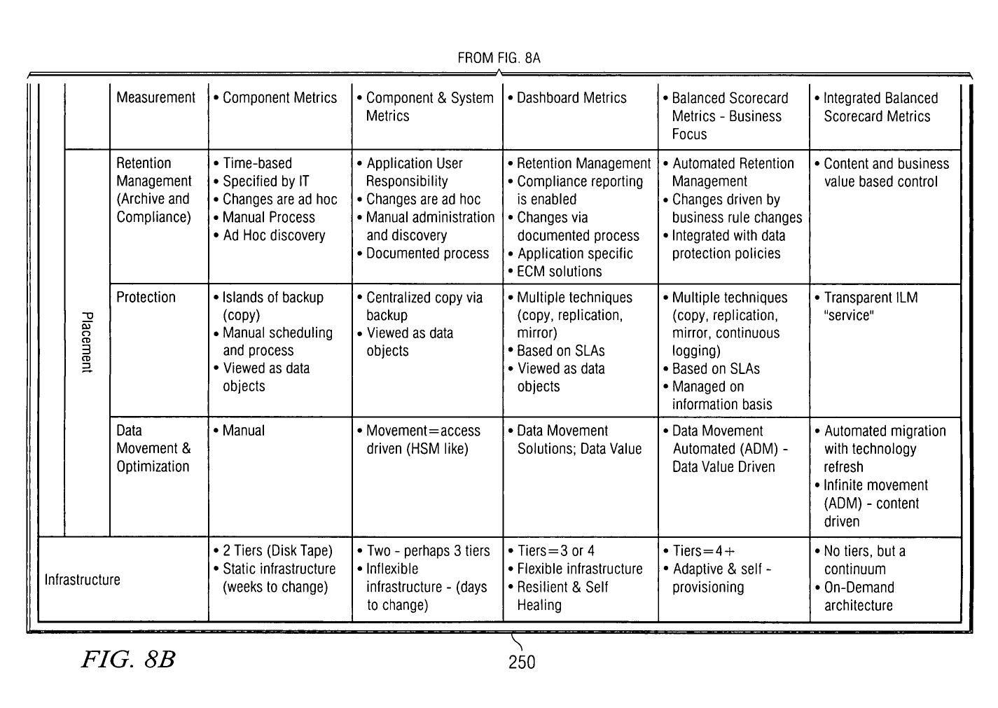

The present invention describes different implementation levels for each stage. Characteristics are provided that describe each level for each stage. FIGS. 8A and 8B depict some of these characteristics for each level for each stage. The assessment tool includes questions about these characteristics.

The assessment tool includes additional questions that ask the user to identify particular relevant issues and check all that are applicable to the user's particular system. In addition, demographic questions are asked, including questions about the user's managed storage capacity, geography, and particular industry.

Once the answers provided by the particular user are collected, a determination is made for each one of the levels to determine in which stage the user's system is currently for that level. In additional, an overall determination is made as to in what stage the user's system is currently overall.

In addition, all of the answers to each one of the questions are compiled as various users use the assessment tool. All of these answers are used to provide average aggregate scores for each level for each stage. In addition, these answers are also used to determine at which level a typical, or average, user's overall system currently exists. The aggregate scores for each level and for the total overall system are presented to the user as a means for comparing the user's system to a “typical” system.

In additional to the total aggregate score for all respondents, the user's system may also be compared to users' systems in the same industry or in other categories. Thus, a chart may be displayed that depicts a typical user's system in the same industry as the current user.

The information management maturity model includes a plurality of contiguous stages. A theoretical information management system would evolve through the stages from an immature stage to a most mature stage. Each stage is a defined stage that is separate and apart from the other stages. Thus, a particular user's system will exist at any particular time within only one stage. As the user's system matures, it will move into a more mature stage.

The maturity stages are characterized by increasing levels of automation and integration, and the depth of alignment between business processes and information lifecycle management. There are unique values associated with moving up to more maturity stages. Evolving to one of the early stages offers increased control of the storage environment and cost savings via optimization and better utilization. Evolving into the latter stages provides substantial reductions in human resources required to manage and administer storage.

According to the preferred embodiment, there are five stages. These stages include the chaotic, reactive, proactive, optimized, and self-aware stages. The most immature stage is the chaotic stage. The most mature stage is the self-aware stage. In between these stages, a system will mature to the reactive stage after the chaotic stage. After the reactive stage, the system will mature into the proactive stage. After the optimized stage, the system will mature into the self-aware stage.

In the chaotic stage, there are no standardized processes. The approach to information management is predominantly an ad hoc approach. At this stage there is storage management anarchy.

In the reactive stage, there are multiple processes and/or procedures in place. In this stage, the information management system relies on individuals' knowledge and experience. Standard documentation is limited to non-existent.

In the proactive stage, there are standardized and documented procedures, although they are generally unsophisticated. There is no method of ensuring compliance with processes, thus it is unlikely that deviations will be detected.

In the optimized stage, the processes are standardized, and compliance is managed. Automated tools are used in a disjointed way.

In this self-aware stage, processes have been elevated to “best practices” levels. Continuous improvement and benchmarking are in place. The information technology (IT) organization supports rapid adaptation to business changes.

The characteristics of a “self-aware” information stage include (1) a complete alignment of IT/business processes based on sophisticated service level management processes, (2) a self-correcting policy engine treating all data as objects with infinite granularity and with actions based on business rules, (3) transparent, automated resource management with automated and pervasive discovery, providing a “living” model of the storage infrastructure and its linkages to business processes, (4) integration of information quality management, content management, security, data protection, and archive and storage optimization, and (5) a virtualized, resilient, self-healing, self-provisioning, and self-balancing storage infrastructure, not representing a tiered architecture, but a continuum of performance options available on a “pay per use” basis.

There is a spectrum of implementation levels that range from a low level hardware implementation level to a high level philosophical level. According to a preferred embodiment, there are five implementation levels. Particular characteristics are specified for each one of the levels for each one of the stages. The five levels include the infrastructure, information placement, storage management integration, business value integration, and business interface levels. FIGS. 8A and 8B include examples of characteristics for each level for each stage.

The Business Interface level defines the relationship of information technology (IT) and business processes. At this level, maturity stages map the development and integration of the IT infrastructure to the business process. In the chaotic stage, the IT driven environment lacks business awareness. In the self-aware stage, there is full integration of IT/business alignment with service level management. In the intermediate stages, there are various levels of development of service management and the changing focus of IT from component management to service management.

The business value integration level defines a linkage between business process and storage management, tying process to policy, data classification, and security. In the chaotic stage there is no linkage. In the self-aware stage, there is full integration, with automated correction. In the intermediate reactive, proactive, and optimized stages, there is some degree of pervasiveness of linkage, management disciplines used and increasing heterogeneity of elements integrated, with the smaller amount of pervasiveness in the reactive stage through a greater degree of pervasiveness in the optimized stage.

A “policy” is defined as an administrative approach that is used to simplify management by establishing rules to deal with situations that are likely to occur. Policies are operating rules that are used as a means of efficiently maintaining order, consistency, and direction. In the chaotic stage, there is no policy. There is uncoordinated decision making. In the self-aware stage, there is an automated situational analysis and self-correcting policy. In the intermediate stages, there is a range depending on a policy implementation of coordinated management, policy, engines, and breadth of policy.

The data classification is a process that defines the access, recovery, and discovery characteristics of an enterprise's different sets of data, grouping them into logical categories to facilitate implementing policy to meet business objectives. In the chaotic stage there is no classification. In the self-aware stage, there are effectively an infinite number of classes. In the intermediate stages, the data classification moves from a low number of classes to a large number, and there is an increase in the involvement of service management in establishing data classes.

The “security” is defined as the management of parameters and settings that make storage resources available to authorized users and trusted networks and unavailable to other entities. These parameters can apply to hardware, programming, communications protocols, and organizational policy. “Security” includes access control, physical security, encryption, and monitoring. In the chaotic stage, there is only physical security. In the self-aware stage, there is automated policy management based security integrated with other ILM services. In the intermediate stages, there are developing stages of proactive security management from a lower level to a higher level.

The storage management integration level supplies the linkage between intended actions (as directed by business requirements) and the actual outcomes of storage administration or management actions. This level includes resource management, metadata management, and measurement functions. Storage management integration matures through stages starting with basic monitoring, followed by management, integration, optimization, and prediction.

In the chaotic stage, there are limited situational knowledge and ad hoc management. In the self-aware stage, there is integrated monitoring and pervasive discovery. In the intermediate stages, there are increasing levels of automation, breadth, and business focus.

Resource management is the process of optimizing the efficiency and speed with which the available storage is utilized. Resource management is generally supported by a Storage Resource Management (SRM) solution. Functions of an SRM program include discovery, data collection, performance analysis, provisioning, and capacity forecasting. Resource management is responsible for maintaining an accurate model of the infrastructure to enable modeling of applications and business processes to infrastructure. Resource management provides critical linkage between business requirements and storage infrastructure. In the chaotic stage, resource management is manual. In the self-aware stage, resource management is automated management with complete discovery. In the intermediate stages, there are increases through the stages in automation levels, pervasiveness, and integration.

Metadata is a description of data. In the chaotic stage, the only information about the data is provided by the operating system, generally including a filename, size, and last access. In the self-aware stage, there are rich reference information about the data including usage and content information, and automated metadata abstraction. Intermediate states include increasing levels of automation, information depth (“richness”), and management. The evolving development of metadata is a key indicator of ILM maturity as it defines when the management of business data objects can progress from a file and record basis to a content basis.

Measurement includes the process and tools used to sense and report on the state (performance, availability, location, etc.) of storage infrastructure and management actions. In order to automate ILM and act on a business value basis, measurement must link the business requirements and value to infrastructure components. In the chaotic stage, measurement is at the component level, e.g. the disk is responding at x MS. In the self-aware stage, measurements are based on business process requirements, presented in a highly actionable format and linked to automated business value integration and placement tools. Intermediate stages involve the evolution of the “topic” of measurement (from components only to business services) and the linkage to automated tools.

The next level is the placement level. Placement is the physical management layer in the ILM maturity model. It involves activities that optimize data location, provides protection copies and structures and manages retention (and disposal) of data. The information placement level includes data protection, retention management, and optimization processes and tools.

In the chaotic stage, placement includes uncoordinated “islands” of placement activity. In the self-aware stage, there is highly mobile information placement, based on content and business value. Intermediate stages are described by increasing automation, business and content awareness, and granularity.

Retention management includes archive and compliance issues. Archival and compliance includes IT processes that manage retention, disposal, security, audit trail, and metadata management. Archival is a process that focuses on keeping the right information over time. Compliance and legal requirements are addressed in the planning, design, architecture, implementation, and operation of an archive. Manual processes, based on activity only, and driven by IT characterize the chaotic stage. In the self-aware stage, retention management is an ILM service driven by content and business value. Intermediate stages involve increasing levels of content awareness, automation, and content management.

Data protection includes any activity that copies, replicates, logs, or moves data for the purposes of safeguarding information. Data protection encompasses the disciplines of backup/restore, disaster recovery, and business continuity. Data Protection Management is a business process, supported by tools and infrastructure, which matches the data protection approach to the business value of information. Uncoordinated islands of backup/recovery capability characterize the chaotic stage. In the self-aware stage, data protection is one of many automated, integrated and optimized, and “content aware” ILM services based on the business value of data. Intermediate stages involve consolidation, automation, breadth of protection approaches, and increases in alignment with business requirements.

Data movement and optimization is a process, supported by tools, which drives efficiency into business while driving costs out. The focus is on making infrastructure more productive by optimizing data placement within tiers of storage to meet service levels and minimize cost. In the chaotic stage, data movement and optimization is manual. In the self-aware stage, data movement and optimization is automated, and business and content aware. Intermediate stages involve the evolution from the base manual state through various degrees of automated data movement, and ultimately to the fully automated state of highest maturity.

The infrastructure level is the physical hardware used to store data and interconnect storage and servers. The infrastructure also includes the software layers used to move, monitor, and manage storage. The chaotic stage is described by static (difficult to change) two-tier storage capacity (disk and tape). The self-aware stage is characterized by adaptive, self-healing infrastructure that provides a continuum of storage environments. Intermediate stages involve the evolution of infrastructure with increasing levels of flexibility, number of tiers and resiliency.

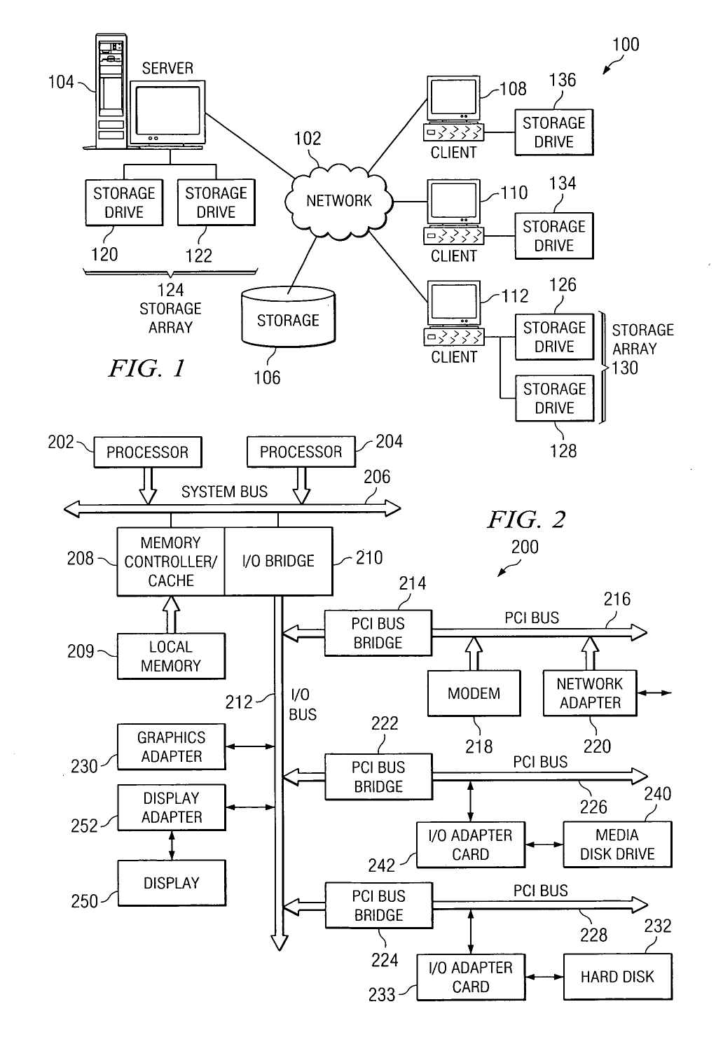

FIG. 1 is a pictorial representation of a network of computer systems that includes the present invention in accordance with the present invention. Network data processing system 100 is a network of computers in which the present invention may be implemented. Network processing system 100 is also an example of a part of a user's current infrastructure implementation.

Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers, network computers, or other computing devices. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 may be the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages.

Of course, network data processing system 100 also may be implemented as a number of different types of networks, such as for example, an intranet, a local area network (LAN), a wide area network (WAN), or a wireless network.

Network system 100 may depict a high level view of a part of a particular user's current infrastructure implementation. Server 104 is coupled to storage drives 120 and 122 which together comprise a storage array 124. Client 112 is coupled to storage drives 126 and 128 which together comprise a storage array 130. Client 110 is coupled to a storage drive 134. Client 108 is coupled to a storage drive 136.

FIG. 1 is intended as an example, and not as an architectural limitation for the present invention.

FIG. 2 is a block diagram of a computer system that may be used to implement the present invention. Computer system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to other computers may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 may also be connected to I/O bus 212 as depicted, either directly or indirectly.

A storage device, such as hard drive 232 is coupled to a PCI bus, such as bus 228, via an I/O adapter card 233. Hard drive 232 may be implemented using any type of technology. For example, hard drive 232 may be a SAS drive or may be a SCSI drive. Adapter card 233 then maps PCI bus as either a SCSI bus or SAS bus depending on the type of interface technology supported by the hard drive 232.

Another storage device, such as a digital media drive 240, is included in system 200. Digital media drive 240 is coupled to PCI bus 226 via an I/O adapter card 242. Digital media drive 240 may be utilized to read data that is stored on a digital storage medium, such as a CD-ROM or a DVD-ROM, when that digital storage medium is inserted into digital media drive 240. Other types of digital storage media may be utilized in digital media drive 240 to play the data that is stored in the digital storage medium.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

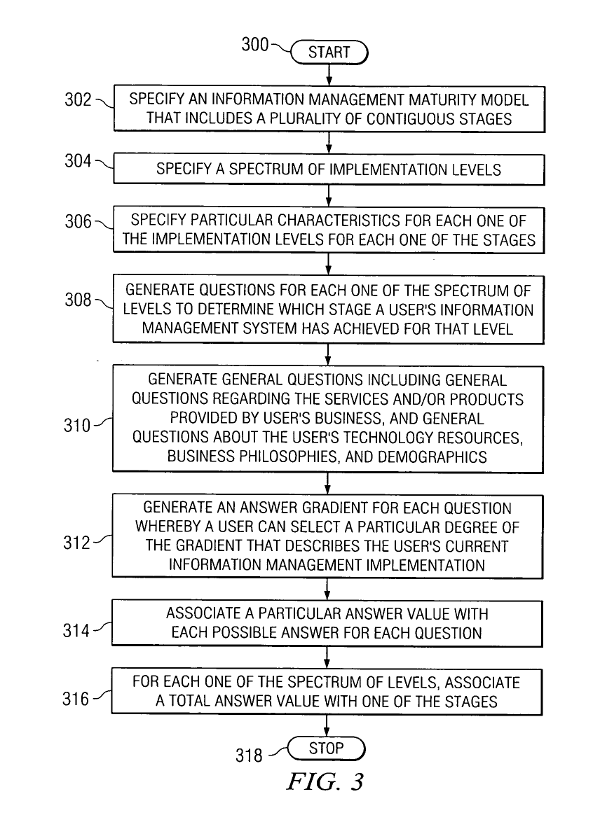

FIG. 3 illustrates a high level flow chart that depicts defining an information maturity model where the model includes a spectrum of levels for each one of a plurality of maturity stages in accordance with the present invention. The process starts as depicted at block 300 and thereafter passes to block 302 which illustrates specifying an information management maturity model that includes a plurality of contiguous stages through which an information management system will evolve. Next, block 304 depicts specifying a spectrum of implementation levels.

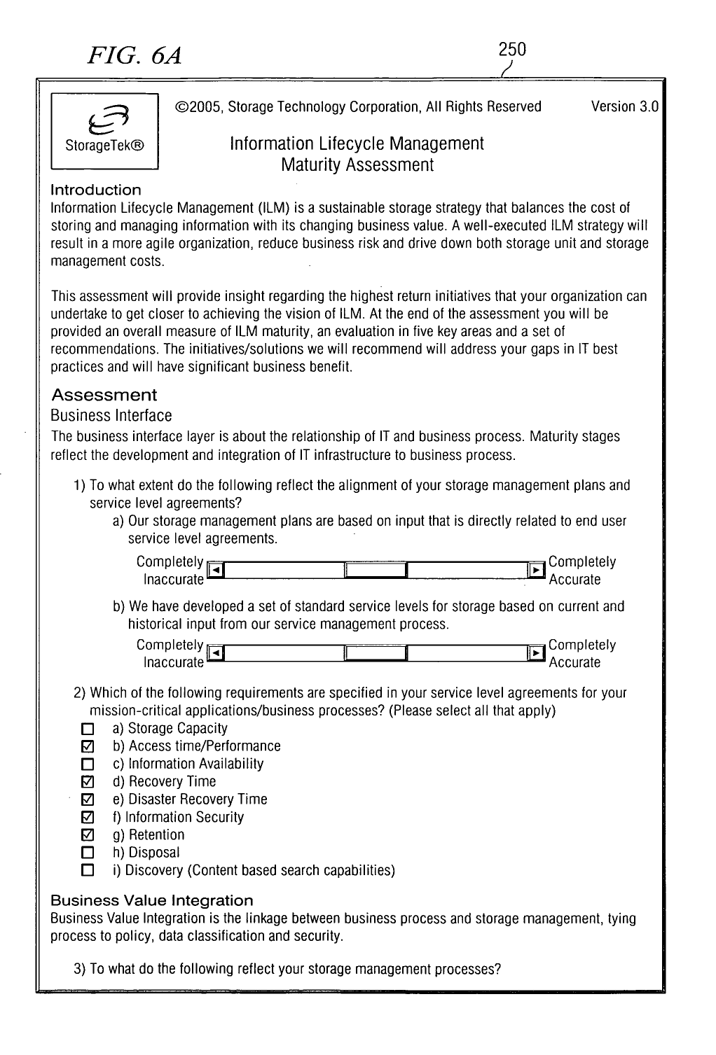

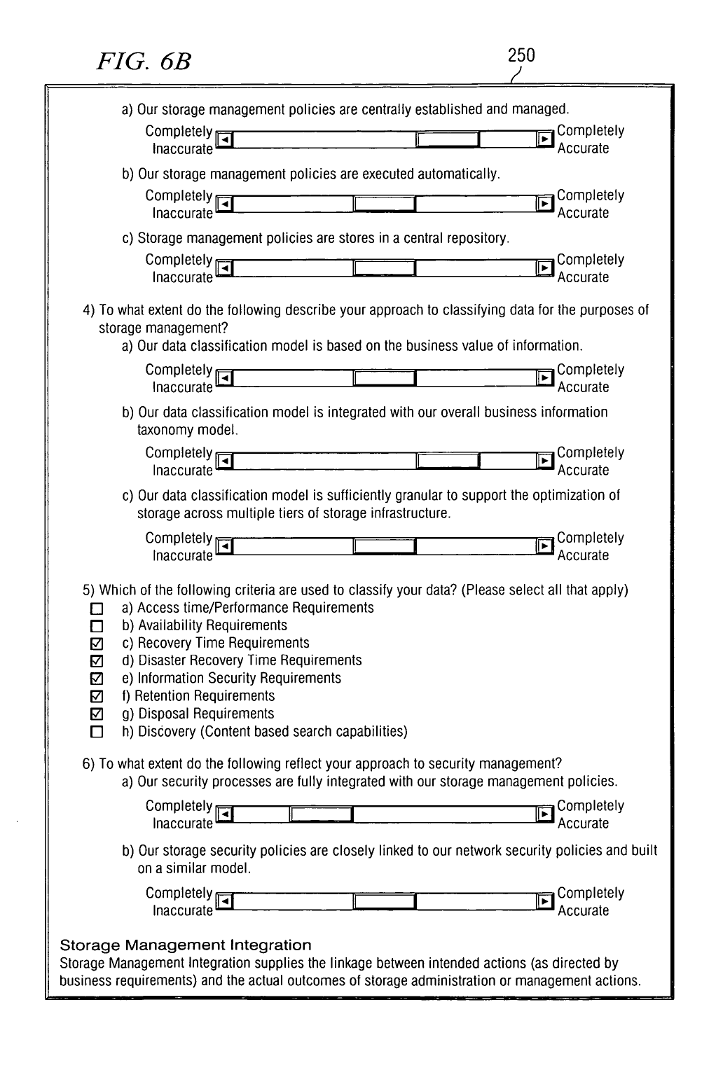

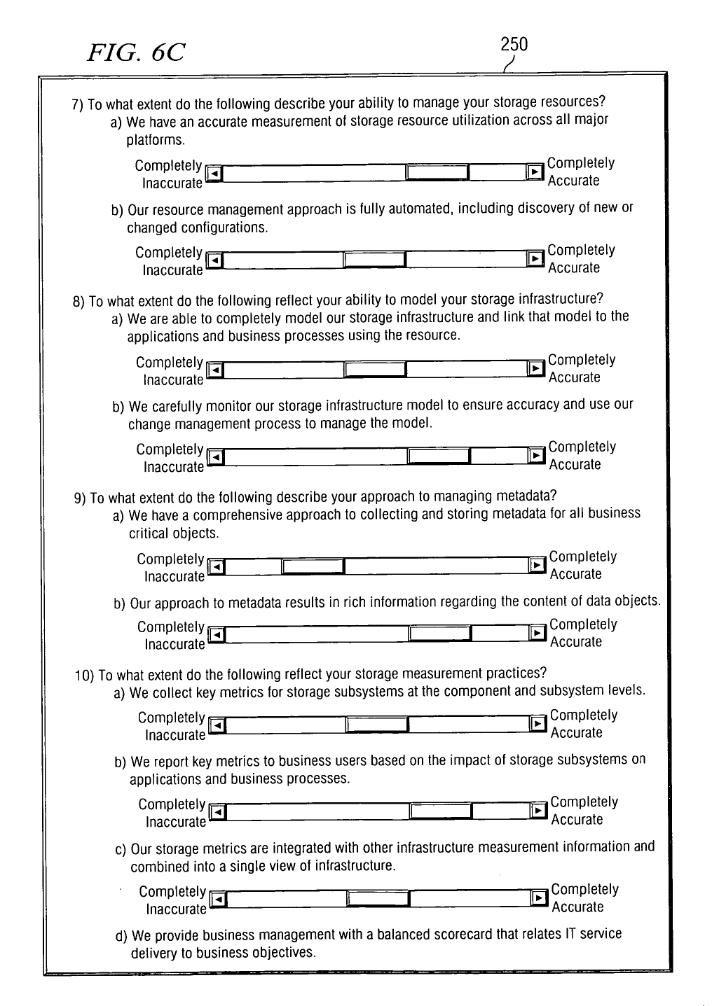

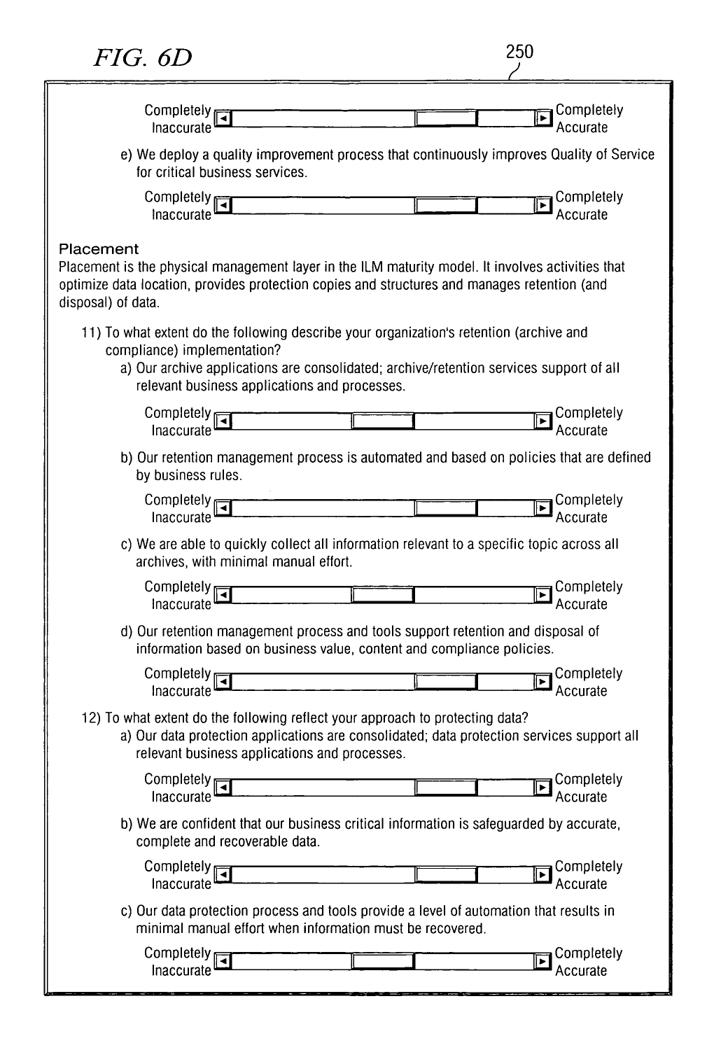

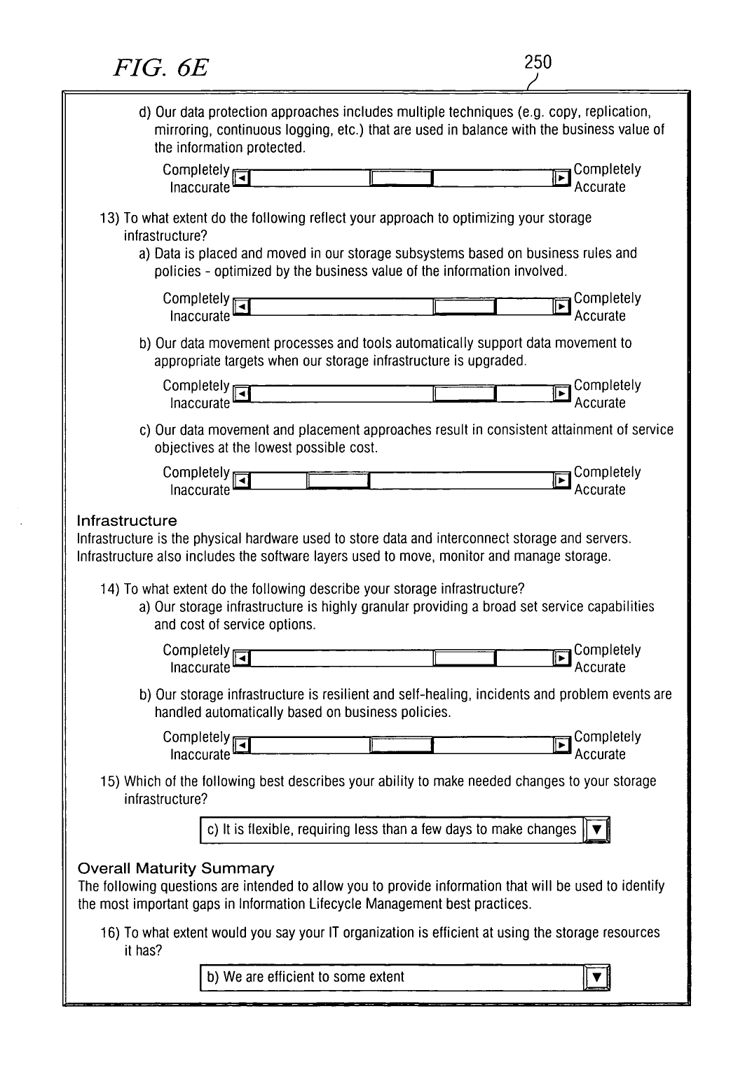

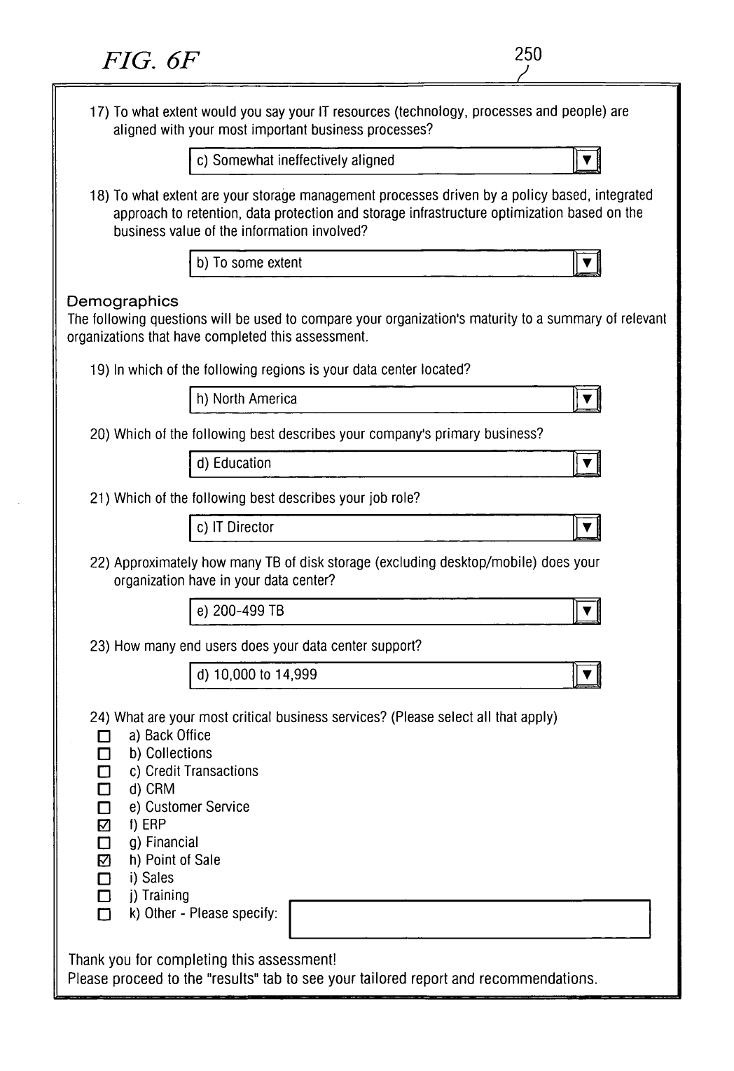

The process then passes to block 306 which illustrates specifying particular characteristics for each one of the implementation levels for each one of the stages. Thereafter, block 308 depicts generating questions for each one of the spectrum of levels to determine which stage a user's information has achieved for that level. Next, block 310 illustrates generating general questions including general questions regarding the services and/or products provided by the user's business, as well as general questions about the user's technology resources, business philosophies, demographics, and other information. FIGS. 6A-6F together depict an example of the questions that may be asked. In addition, questions may be associated with one or more levels. Thus, for example, there may be a group of questions that relate to the “business interface” level, as well as groups of questions that relate to the other levels.

The process then passes to block 312 which depicts generating an answer gradient for each question whereby a user can select a particular degree of the gradient that describes the user's current information management system implementation. FIGS. 6A-6F depict an answer gradient for some questions that ranges from “completely inaccurate” to “completely accurate”. A user may then select a position along the gradient that indicates the user's answer.

Next, block 314 illustrates associating a particular answer value with each possible answer for each question. Thereafter, block 316 depicts for each one of the spectrum of levels, associating a total answer value with one of the stages. For each stage, this total answer value is the number that must be achieved in order for a system to be considered to be in that stage. The process then terminates as illustrated by block 318.

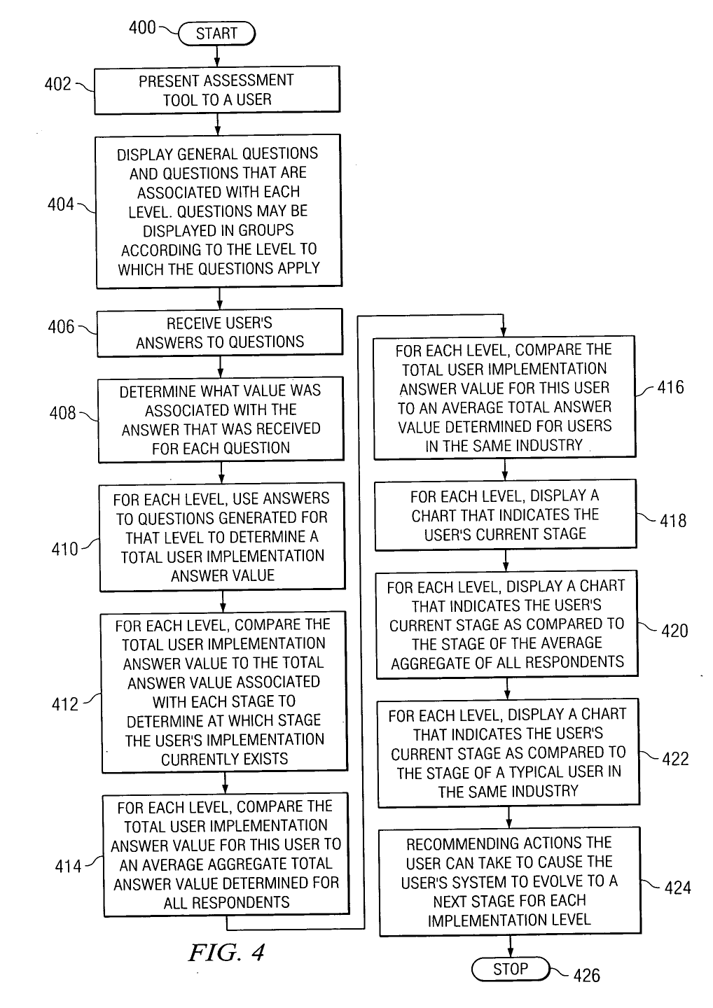

FIG. 4 depicts a high level flow chart that illustrates presenting and utilizing an assessment tool to analyze a user's current information management system in accordance with the present invention. The process starts as depicted by block 400 and thereafter passes to block 402 which illustrates presenting the assessment tool to a user. Next, block 404 depicts displaying general questions and questions that are associated with each level. Questions may be displayed in groups according to the level to which the questions apply. Thereafter, block 406 illustrates receiving a user's answers to the questions. Block 408, then, depicts determining what value was associated with the answer that was received for each question.

The process then passes to block 410 which illustrates for each level, using the answers to the questions generated for that level to determine a total user implementation value for that level. Therefore, all of the answers to the questions that are associated with a particular level are added together.

In addition, some questions may be weighted such that answers to those questions may receive a higher value. In the case where a question is weighted, the answer may be multiplied times a weighting value. This weighted value is then added to the answers to the remaining questions that are associated with that level to determine a total answer value for the level.

Next, block 412 depicts for each level, comparing the total user implementation answer value to the total answer value associated with each stage to determine at which stage the user's implementation currently exists. Next, block 414 illustrates for each level, comparing the total user implementation answer value for this user to an aggregate total answer value that was determined for all respondents. The answers entered into the assessment tool by a user are kept and added to the answers entered by previous users. In this manner, an average aggregate value can be determined for each level and for the total system.

The process then passes to block 416 which depicts for each level, comparing the total user implementation answer value for this user to an average total answer value that was determined for users that are in the same industry as the current user. Thereafter, block 418 illustrates for each level, displaying a chart that indicates the user's current stage.

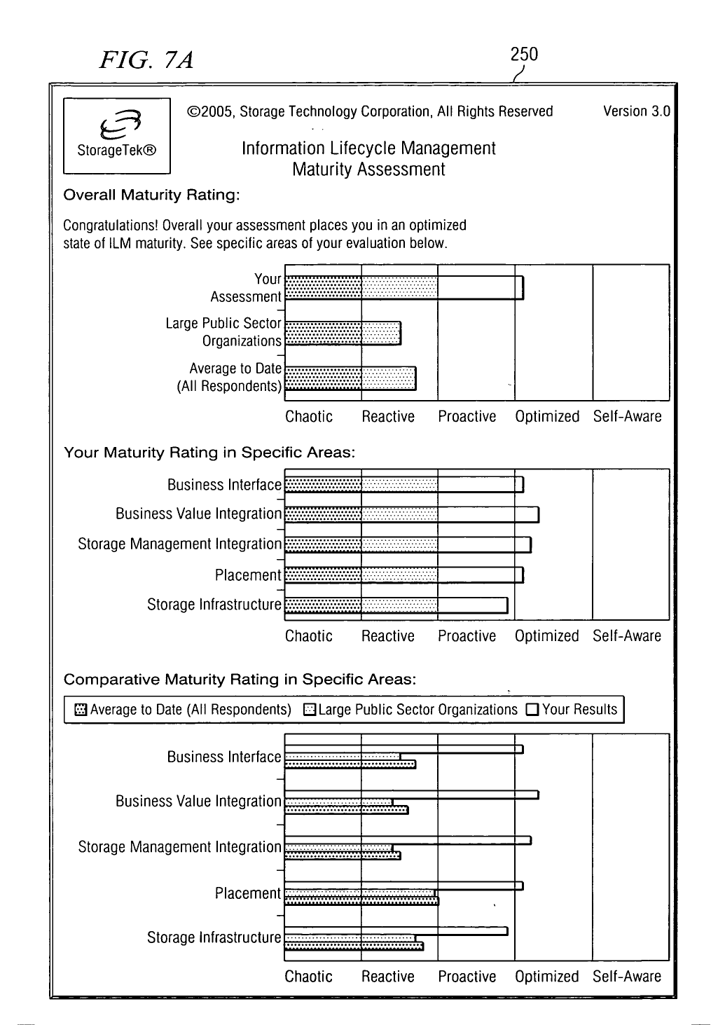

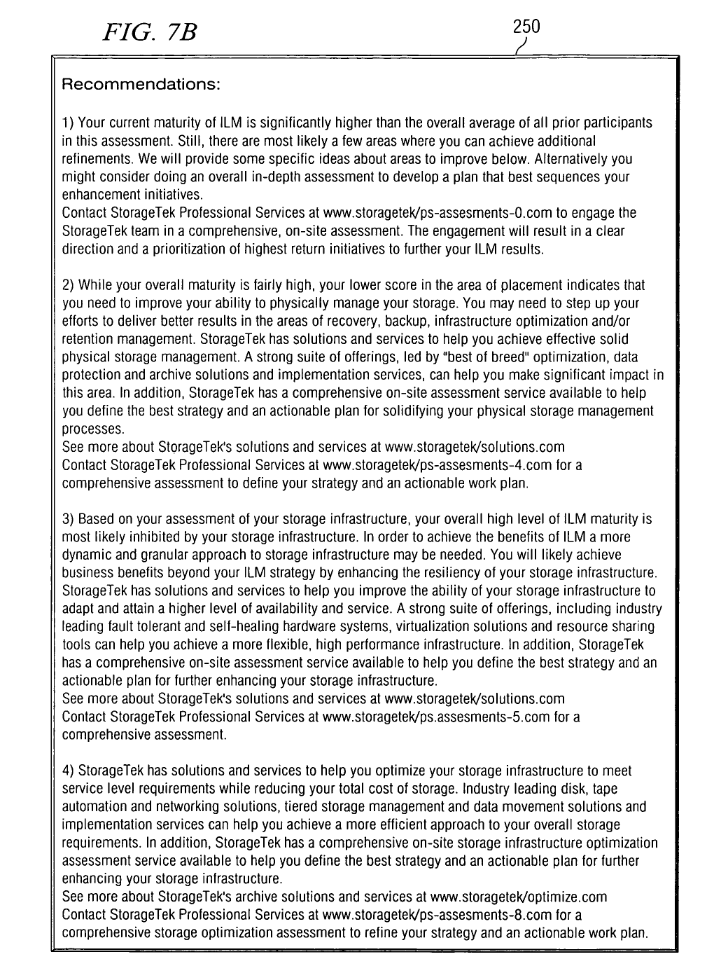

Next, block 420 depicts for each level, displaying a chart that indicates the user's current stage as compared to the stage of the average aggregate of all respondents. Block 422, then, illustrates for each level, displaying a chart that indicates the user's current stage as compared to the stage of a typical user in the same industry as the current user. Thereafter, block 424 depicts recommending actions the user can take to cause the user's system to evolve to the next stage for each implementation level. FIGS. 7A and 7B together depict the resulting assessment of an exemplary user as well as the recommendations that were made for that user. The process then terminates as depicted by block 426.

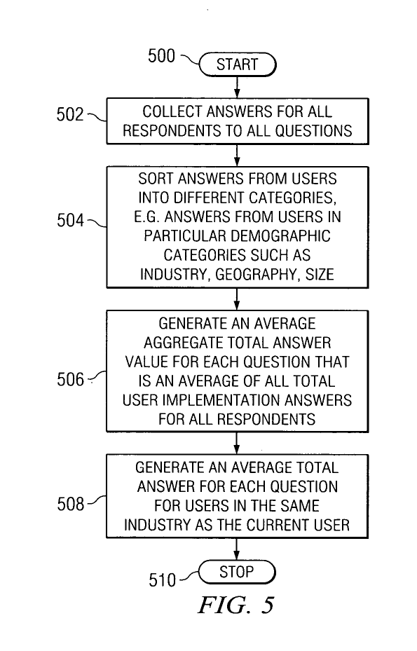

FIG. 5 illustrates a high level flow chart that depicts collecting respondents' answers to an assessment tool to generate average aggregate answers in accordance with the present invention. The process starts as depicted by block 500 and thereafter passes to block 502 which illustrates collecting answer for all respondents to all questions. Next, block 504 depicts sorting answers from all users into different categories. For example, the answers may be sorted into demographic categories such as by user's industry, geography, and size. The process then passes to block 506 which illustrates generating an average aggregate total answer value for each question that is an average of all total user implementation answers for all respondents. Block 508, then, depicts generating an average total answer for each question for users in the same industry as the current user. The process then terminates as illustrated by block 510.

Those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for assessing a user's current information management system, said method comprising:
defining a plurality of contiguous information management system stages;
defining a plurality of implementation levels;
specifying particular characteristics for said plurality of implementation levels for each one of said plurality of stages;
generating a plurality of questions regarding said particular characteristics;
receiving answers from a user to said plurality of questions; and
determining in which one of said plurality of stages said user's current information management system exists utilizing said received answers.

2. The method according to claim 1, further comprising:
associating a total answer value with each one of said plurality of stages, wherein said total answer value indicates in which one of said plurality of stages said user's current information management system exists.

3. The method according to claim 2, further comprising:
assigning an answer value to each potential answer to said plurality of questions;
determining an answer value for each one of said received answers to each one of said plurality of questions;
determining said user's total answer value by totaling all answer values for each one of said received answers to each one of said plurality of questions; and
determining in which one of said plurality of stages said user's current information management system exists by comparing said user's total answer value to said total answer value associated with each one of said plurality of stages.

4. The method according to claim 3, further comprising:
weighting an answer value for a selected one of said plurality of questions more heavily than answer values for others of said plurality of questions; and
determining said user's total answer value by totaling all answer values for each one of said received answers to each one of said plurality of questions, wherein said answer value for said selected one of said plurality of questions represents a greater percentage of said total answer value than any answer value for any of said other of said plurality of questions.

5. The method according to claim 1, further comprising:
for each one of said plurality of implementation levels, associating a total answer value with each one of said plurality of stages, wherein said total answer value indicates in which one of said plurality of stages said user's current information management system exists.

6. The method according to claim 5, further comprising:
associating each one of said plurality of questions with one of said plurality of implementation levels;
assigning an answer value to each potential answer to said plurality of questions;
determining an answer value for each one of said received answers to each one of said plurality of questions;
determining said user's total answer value for one of said plurality of levels by totaling all answer values for each one of said received answers to ones of said plurality of questions that are associated with said one of said plurality of implementation levels; and
determining, for said one of said plurality of implementation levels, in which one of said plurality of stages said user's current information management system exists by comparing said user's total answer value to said total answer value associated with each one of said plurality of stages.

7. The method according to claim 1, further comprising:
receiving answers from a plurality of other users to said plurality of questions; and
determining in which one of said plurality of stages an average user's current information management system exists.

8. The method according to claim 7, further comprising:
associating a total answer value with each one of said plurality of stages, wherein said total answer value indicates in which one of said plurality of stages an information management system exists;
assigning an answer value to each potential answer to said plurality of questions;
determining an answer value for each one of said received answers to each one of said plurality of questions for each one of said plurality of other users;
determining an answer value for each one of said received answers to each one of said plurality of questions for each one of said user;
determining said user's total answer value by totaling all answer values for each one of said received answers to each one of said plurality of questions;
determining an average aggregate total answer value by totaling all answer values for each one of said received answers to each one of said plurality of questions for said plurality of other users and computing an average of said totaled answer values;
determining in which one of said plurality of stages said user's current information management system exists by comparing said user's total answer value to said total answer value associated with each one of said plurality of stages;
determining in which one of said plurality of stages an average user's current information management system exists by comparing said average aggregate total answer value to said total answer value associated with each one of said plurality of stages; and
comparing said one of said plurality of stages in which an average user's current information management system exists to said one of said plurality of stages in which said user's current information management system exists.

9. The method according to claim 1, further comprising:
recommending actions said user can take to cause said user's current information management system to evolve to a next one of said plurality of stages beyond said one of said plurality of stages in which said user's current information management system exists.

10. An apparatus in a data processing system for assessing a user's current information management system, said apparatus comprising:
a plurality of contiguous information management system stages;
a plurality of implementation levels;
particular characteristics being specified for said plurality of implementation levels for each one of said plurality of stages;
a plurality of questions regarding said particular characteristics;
said data processing system including a CPU executing code for receiving answers from a user to said plurality of questions; and
said CPU executing code for determining in which one of said plurality of stages said user's current information management system exists utilizing said received answers.

11. The apparatus according to claim 10, further comprising:
a total answer value being associated with each one of said plurality of stages, wherein said total answer value indicates in which one of said plurality of stages said user's current information management system exists.

12. The apparatus according to claim 11, further comprising:
an answer value assigned to each potential answer to said plurality of questions;
said CPU executing code for determining an answer value for each one of said received answers to each one of said plurality of questions;
said CPU executing code for determining said user's total answer value by totaling all answer values for each one of said received answers to each one of said plurality of questions; and
said CPU executing code for determining in which one of said plurality of stages said user's current information management system exists by comparing said user's total answer value to said total answer value associated with each one of said plurality of stages.

13. The apparatus according to claim 12, further comprising:
an answer value for a selected one of said plurality of questions being weighted more heavily than answer values for others of said plurality of questions; and
said CPU executing code for determining said user's total answer value by totaling all answer values for each one of said received answers to each one of said plurality of questions, wherein said answer value for said selected one of said plurality of questions represents a greater percentage of said total answer value than any answer value for any of said other of said plurality of questions.

14. The apparatus according to claim 10, further comprising:
for each one of said plurality of implementation levels, a total answer value being associated with each one of said plurality of stages, wherein said total answer value indicates in which one of said plurality of stages said user's current information management system exists.

15. The apparatus according to claim 14, further comprising:
each one of said plurality of questions being associated with one of said plurality of implementation levels;
an answer value assigned to each potential answer to said plurality of questions;
said CPU executing code for determining an answer value for each one of said received answers to each one of said plurality of questions;
said CPU executing code for determining said user's total answer value for one of said plurality of levels by totaling all answer values for each one of said received answers to ones of said plurality of questions that are associated with said one of said plurality of implementation levels; and
said CPU executing code for determining, for said one of said plurality of implementation levels, in which one of said plurality of stages said user's current information management system exists by comparing said user's total answer value to said total answer value associated with each one of said plurality of stages.

16. The apparatus according to claim 10, further comprising:
answers being received from a plurality of other users to said plurality of questions; and
said CPU executing code for determining in which one of said plurality of stages an average user's current information management system exists.

17. The apparatus according to claim 16, further comprising:
a total answer value being associated with each one of said plurality of stages, wherein said total answer value indicates in which one of said plurality of stages an information management system exists;
an answer value assigned to each potential answer to said plurality of questions;
said CPU executing code for determining an answer value for each one of said received answers to each one of said plurality of questions for each one of said plurality of other users;
said CPU executing code for determining an answer value for each one of said received answers to each one of said plurality of questions for each one of said user;
said CPU executing code for determining said user's total answer value by totaling all answer values for each one of said received answers to each one of said plurality of questions;
said CPU executing code for determining an average aggregate total answer value by totaling all answer values for each one of said received answers to each one of said plurality of questions for said plurality of other users and computing an average of said totaled answer values;
said CPU executing code for determining in which one of said plurality of stages said user's current information management system exists by comparing said user's total answer value to said total answer value associated with each one of said plurality of stages;
said CPU executing code for determining in which one of said plurality of stages an average user's current information management system exists by comparing said average aggregate total answer value to said total answer value associated with each one of said plurality of stages; and
said CPU executing code for comparing said one of said plurality of stages in which an average user's current information management system exists to said one of said plurality of stages in which said user's current information management system exists.

18. The apparatus according to claim 10, further comprising:
said CPU executing code for recommending actions said user can take to cause said user's current information management system to evolve to a next one of said plurality of stages beyond said one of said plurality of stages in which said user's current information management system exists.

19. A computer program product for assessing a user's current information management system, said product comprising:
instructions for defining a plurality of contiguous information management system stages;
instructions for defining a plurality of implementation levels;
instructions for specifying particular characteristics for said plurality of implementation levels for each one of said plurality of stages;
instructions for generating a plurality of questions regarding said particular characteristics;
instructions for receiving answers from a user to said plurality of questions; and
instructions for determining in which one of said plurality of stages said user's current information management system exists utilizing said received answers.

20. The product according to claim 19, further comprising:
instructions for associating a total answer value with each one of said plurality of stages, wherein said total answer value indicates in which one of said plurality of stages said user's current information management system exists;
instructions for assigning an answer value to each potential answer to said plurality of questions;
instructions for determining an answer value for each one of said received answers to each one of said plurality of questions;
instructions for determining said user's total answer value by totaling all answer values for each one of said received answers to each one of said plurality of questions; and
instructions for determining in which one of said plurality of stages said user's current information management system exists by comparing said user's total answer value to said total answer value associated with each one of said plurality of stages.
